(19) United States
(12) Patent Application Publication
(10) Pub. No.: US 2011/0018277 A1
(43) Pub. Date: Jan. 27, 2011

(54) HYDROKINETIC ELECTRICAL POWER GENERATION SYSTEM

(76) Inventor: Michael Wayne Brace, Maysville, KY (US)

Correspondence Address: Michael Wayne Brace, 8166 Day Pike, Maysville, KY, 41056-9229, US

(21) Appl. No.: 12/508,990

(22) Filed: Jul. 24, 2009

(51) Int. Cl. F03B 13/10

(52) U.S. Cl. 290/54; 290/53

(57) ABSTRACT

A Hydrokinetic Electrical Power Generation Station (HEPGS) is disclosed which converts unimpeded river, ocean and tidal flow currents into useful electrical power on a very large scale (>6 MW each). This innovative approach requires no additional structures to be built on land (or in the water), there are no fast moving components and it has little to no ecological impact to the aquatic environment. They are designed to operate well below river traffic navigating on the surface and withstand the impact of debris floating under it. They are modular in construction which allows for the setup, upgrade, monitoring and any unexpected maintenance using conventional barging technology. They can be used as the soul source of electrical power for communities close to flowing rivers (or ocean currents) or they can supplement existing power generation stations located near large rivers thus helping to reduce (and eliminate) their use of non-renewable fuel.

### FIELD

The present disclosure relates to hydrokinetic electrical power generation, more specifically a mechanical system by which to extract mechanical energy from flowing currents and convert that energy into rotary motion which in turn can then be converted into electrical energy.

### BACKGROUND

There are a lot hydrokinetic electrical power generators being used today that convert the current flow of rivers and oceans into useful mechanical power. In order to achieve a commercially viable amount of electricity from these hydrokinetic electrical power generators (for distribution on a large scale) the method commonly being used to convert the linear motion of the current into rotary motion is done through the use of hydrofoils and turbine blades fixed on one (or more) rotating disk on a horizontal axis. Such is the case found in modern hydro-electrical dams and other type devices.

While in themselves hydrofoils and turbines are by no means ineffective in the conversion of linear forces to rotary forces, by their very design they are not very efficient and are limited in scope and breadth due to their very nature of having a vertically oriented turbine (normal to the current flow) affixed to a horizontally rotating axis. This also means that most of these hydrofoils and turbines are limited in diameter by the depth of the water in which they operate. Since the power derived from this method is based on the torque provided to the disk (this is a function of the diameter of the disk) and the rotational speed of the disk, this means that in order to provide substantially viable mechanical power these designs must operate with a rotating disk speed that is faster than the prevailing current speed. To increase power they have little choice other than to increase current velocity.

Due to their very nature hydrofoils and turbine disks have numerous blades with narrow leading edges. Because these blades move faster than [and are normal to] the water current they can cause severe damage to any living organism that is impacted by them during normal operation and they themselves are easily damaged due to impact of foreign objects. Precautions can be taken (such as screens or inlet restrictions) to help mitigate damage to themselves and to the aquatic life in and around these inlets but in addition to restricting flow (and lessening their efficiency) by no means can they ensure the safety of said life during normal operations and (as often is the case) there are a lot of fish (and other such organisms) that are killed because of being trapped against said screens. These screens must also be periodically unclogged. This results in substantial maintenance cost with not additional benefit.

Furthermore, because hydrofoils and turbine blades must operate at faster-than-nominal current speeds they must often be accompanied by additional man-made structures and flow restriction devices (used to increase current velocity) such as dams, flues, conduits, ducts or pipes. These additional structures can add significant cost to the device, severely limit where this technology can be applied, and they impact the local aquatic species and environment in an adverse manner through construction and habitation damage. In many cases it also exposes portions of the construction to severe weather (this in turn can cause seasonal or unplanned power outages) and accordingly presents hazards to navigation. At the present time most other technologies are not only severely limited in where they can be placed, but disrupt and damage the environment and impede surface traffic to an unacceptable level and often in a permanent manner.

### SUMMARY

According to the present disclosure it is possible to construct and employ a totally submerged hydrokinetic electrical generator that is not only unrestricted in where is can be placed and operated, but one that has no faster-than-current components to damage any aquatic life, one that needs no additional structures or restrictions for its normal use, one that all components remain totally submerged (and out of severe weather), one that is more efficient at translating linear flow to rotational torque, one that is strong enough to withstand severe impacts from floating debris (and not quit working), and one that is benign to the environment in which it operates; be it inland or offshore. Most importantly this present disclosure is only restricted in rotational diameter size by the width of the water way, not the depth. This allows our invention to deliver significantly more power than ever derived before from any other type of self-contained hydro-powered device operating in unimpeded water currents.

More specifically this mechanical device was also designed and sized to be submerged right along side existing on-shore power plants (located near a large river or ocean current) so that the electrical power derived from this mechanical device can be routed right into the on-shore power station thereby helping the on-shore power station reduce its dependency on a non-renewable fuel source.

### DRAWINGS

The drawings described herein are for illustration purposes only, the components are not scaled relative to each other, and accordingly they are not intended to limit the scope of the present disclosure in any way. The drawings presented are as follows:

FIG. 1 is a perspective view of the present disclosure.

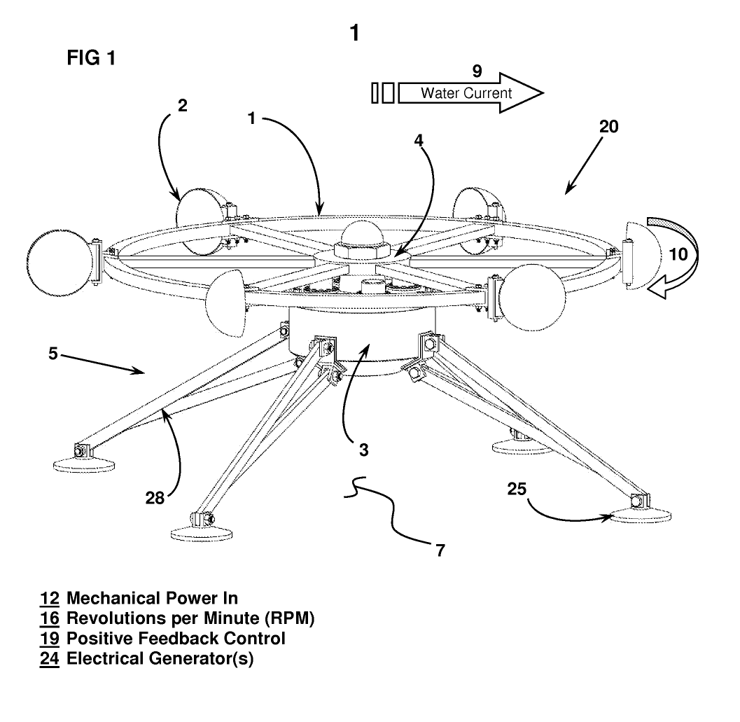

FIG. 2 is a perspective view of the present disclosure as placed in its normal operating environment, submerged completely beneath the surface of the water and in a current.

FIG. 3 is a perspective view of the present disclosure with specifications as to where it is placed in its normal operating environment.

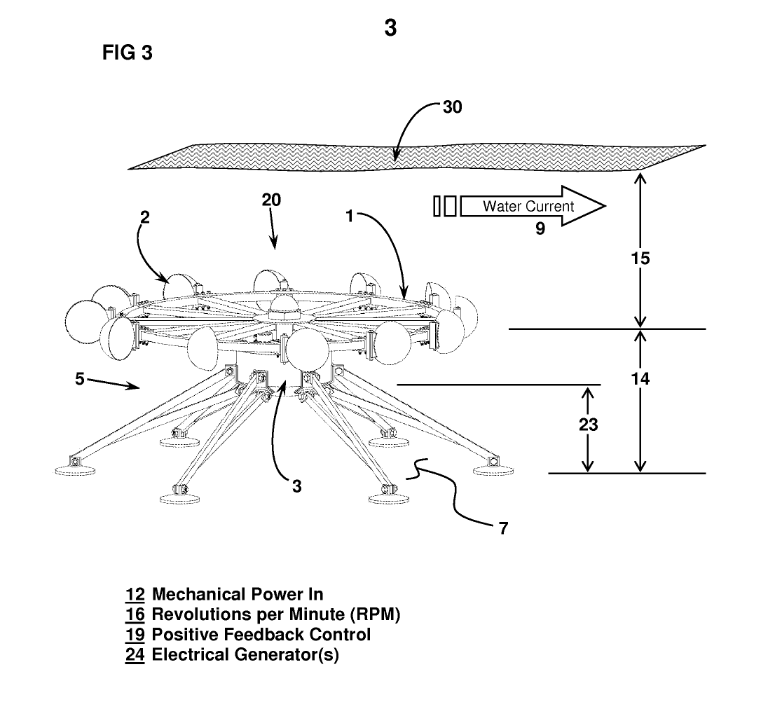

FIG. 4 is a simple schematic illustrating the relationship of the present disclosure in multiple quantities to its environment and their relationship to on-shore features.

FIG. 5 is a perspective view of the present disclosure with modifications to design based on its operating environment.

FIG. 6 is a shaded perspective view of the present disclosure in its operating environment.

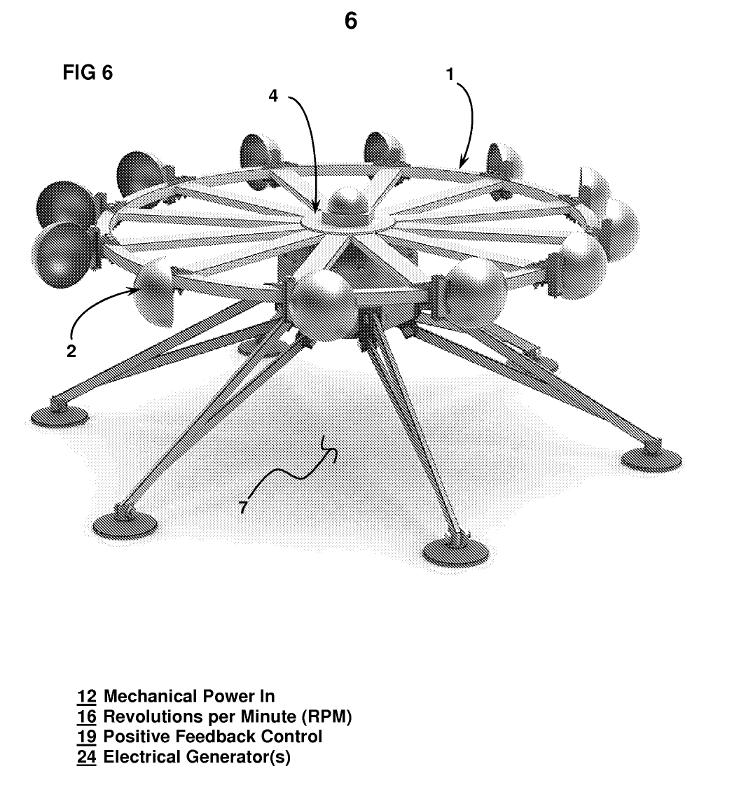

### DESCRIPTION OF THE PREFERRED EMBODIMENT

An Hydrokinetic Electrical Powered Generation System (HEPGS) 20 that is specifically designed to operate in flowing water currents such as those found in rivers 8, oceans (not pictured) or other such natural waterways (not pictured) completely submerged beneath the surface 30 in a manner such that it transfers the linear motion of flowing current 9 into rotary motion 10 through the use of a horizontally positioned power wheel 1 that rotates along a vertical axis of rotation. The power wheel 1 has along its circumference a series of cups 2 whose task is to provide the resistance to the current 9 so as to cause the power wheel 1 to rotate along its vertical axis which is normal (90°) to the current 9. This rotary mechanical power in 12 is transferred via a mechanical connection at the hub 4 (not described herein) into the electrical generator housing 3 located at the center of rotation of the power wheel 1.

A further disclosure of the power wheel 1 and cup 2 assembly is that once configured to rotate in either direction (clock-wise or counter clock-wise) the will rotate in that direction with 100% effectiveness regardless of which direction the current 9 comes from. Shifting currents 9 and ebb & flow currents 9 (tidal currents 9) have no adverse effect on the operation of the power wheel 1 nor the mechanical power in 12. Once the diameter of the power wheel 1 and the number of cups 2 and the size of the cups 2 are determined and placed in operation the mechanical power in 12 is strictly based on current 9 speed and not current 9 direction.

The diameter of the power wheel 1 is sized according to the current 9 provided so as to deliver the desired mechanical power in 12 to produce the desired electrical energy out 13 (via submerged electrical cables 17) through the use of one (or more) electrical generators 24 (not detailed in these figures) located in electrical generator housing 3 located at the hub 4 of the power wheel 1. It is also disclosed that the shape, location and surface area of cups 2 (which are located as such at the periphery of the power wheel 1) are of such size and such shape and such design as to provide the required resistance (caused by current 9) specific to the location where the HEPGS 20 is submerged. The cups 2 provide the torsional mechanical power in 12 to the power wheel 1. In the accompanied drawings (and for illustration purposes only) the cups 2 are illustrated as semi-spherical hollow shapes but to those knowledgeable in the industry they could be configured to any degree of ellipse, any periphery shape and any depth of draw to meet the resistance requirements of the power wheel 1 based on the environment where HYPEGS 20 are located.

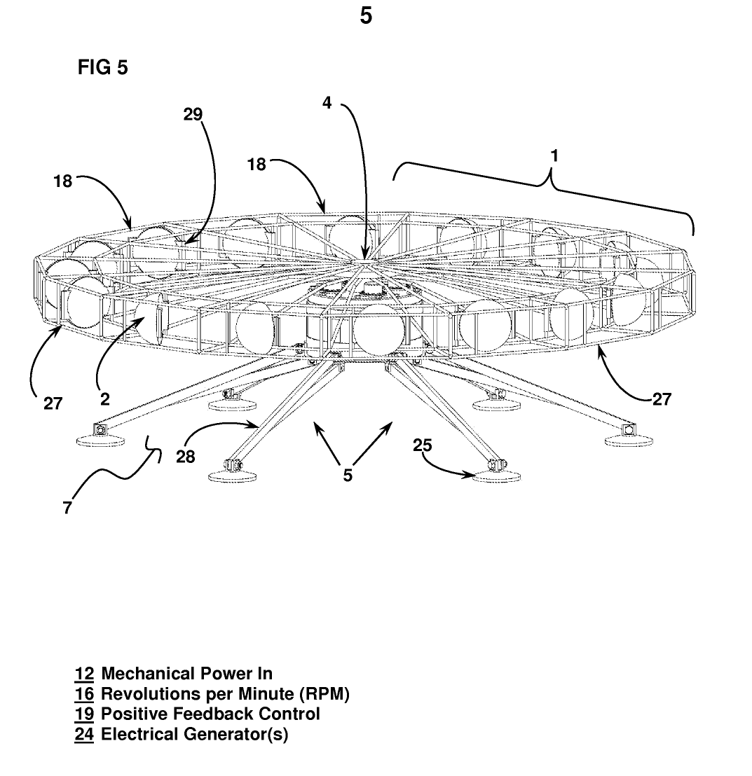

A further disclosure of the power wheel 1 is that it can be designed to enclose the cups 2 within an upper periphery structure 18 and a lower periphery structure 27 of appropriate size, shape, strength and configuration to serve as a protective barrier against partially submerged floating debris (not pictured) being carried by current 9 that may impact power wheel 1 during normal operation. See FIG. 5 for this configuration.

The cups 2 located along the periphery of the power wheel 1 may be modulated in and out of the horizontal plane within the rotational plane of the power wheel 1 by a hinge mechanism 29 so as to provide a mechanical means of controlling the mechanical power out 12 of the rotating power wheel 1 by modulating the rotational speed (or revolutions per minute; RPM) 16 of the power wheel 1. When modulating the cups 2 (in and out of the horizontal plane within the rotational plane of the power wheel 1) on one side of the power wheel 1 the vast difference in resistance to the current 9 on one side of the power wheel 1 can increase or decrease the torsional mechanical power in 12. The cups 2 can be adjusted in and out of the horizontal plane of rotation by a hinge mechanism 29 such that each cup's 2 tangential velocity is used to maintain the optimum RPM 16 of the rotating power wheel 1 for the operation of the electrical generators 24 located in the generator housing 3. It is understood by those skilled in the art that said hinge mechanism 29 can be configured differently as illustrated to meet the design and scale of the cups 2 and the needs of the power wheel 1 and that they are shown as such for illustration purposes only.

The electrical generator housing 3 is attached to the base 5 which serves to elevate the electrical generator housing 3 off the river bed/ocean floor 7 (herein referred to simply as the river bed 7) to a determined elevation 23 off the river bed 7 as well as to a determined depth 15 of the power wheel 1 under the surface of the river 30 so as to optimize the ratio of current 9 to rotary motion 10 for the desired mechanical power in 12. The base 5 is also used to set the depth 15 of the power wheel 1 such that the power wheel 1 does not create a hindrance to navigation for the vehicle traffic on the surface of the river 30 and also to avoid damage due to impact from debris (not pictured) floating on the surface of the river 30 or lumbering along the river bed 7 in the river 8. The base 5 is also of such design and configuration when used to set the elevation 23 of the generator housing 3 such that river silt (not pictured) being carried down the river 8 due to the current 9 does not build up on, or about the base 5 nor the electrical generator housing 3.

The electrical generators 24 located in electrical generator housing 3 are installed in such a manner and configuration as to provide positive feed-back control 19 to the power wheel 1 to control the RPM 16 of the power wheel 1 by increasing or decreasing the electrical impedance drag created in the electrical generators 24 set by the demand of the electrical power out 13 of the electrical generators 24. By varying the demand of electrical energy out 13 of the electrical generators 24 the RPM 16 of the power wheel 1 can be optimized for variations in velocity of the current 9.

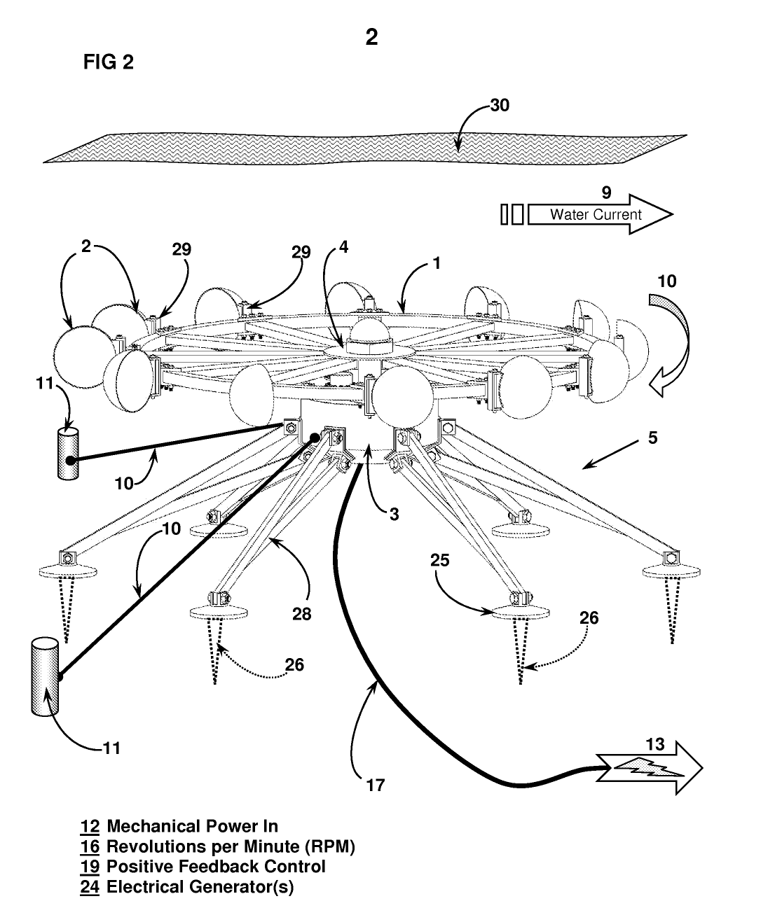

In order to keep the current 9 from moving the HEPGS 20 to an undesirable position along the river bed 7 the base 5 is secured to the river bed 7 via conventional means such as lanyards 10 which are secured to either the base 5 or the electrical generator housing 3 (as shown in FIG. 2) and then secured to a series of pylons 11 embedded into the river bed 7 to a depth effective for the size and number of pylons 11 used.

The base 5 is comprised of legs 28 of the appropriate number, length, girth and structure to support to total weight of the HEPGS 20 and are designed of a proper cross-sectional shape (not detailed) for the environment in which the HEPGS 20 is located. Each leg 28 on the base 5 has a foundation 25 (herein referred to as feet 25) that are configured to aid in securing HEPGS 20 to the river bed 7 through the use of protrusions 26 (shown in FIG. 2 as hidden lines) located on the bottom side of feet 25 which imbed themselves in the river bed 7 when the unit is placed in the desired location. The length, shape and exact location of these protrusions 26 on feet 25 are not specified herein.

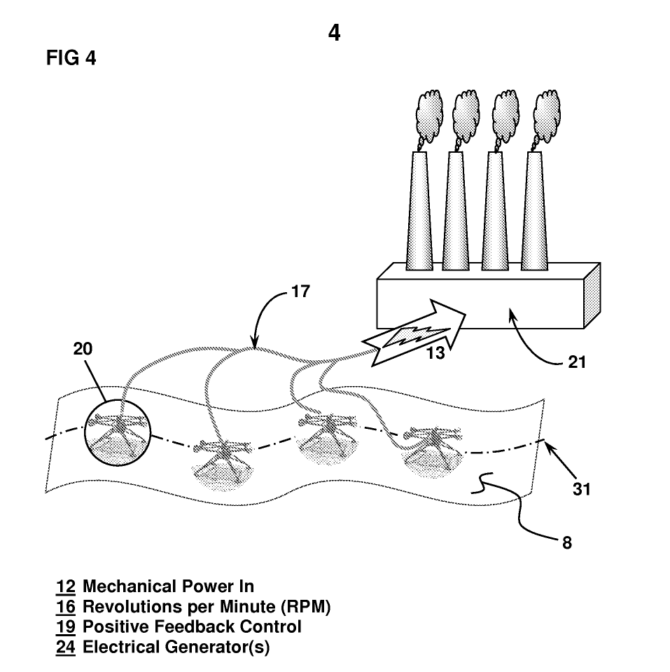

The HEPGS 20 is situated along the river bed 7 in such a manner as to lie at (or near) the center line 31 of the river 8 where the ratio of the flow volume to unit area of the river 8 is at its greatest. If more than one HEPGS 20 is located within the vicinity of another HEPGS 20 it should be located in-line with the other HEPGS 20 being used at the same river 8 location (see FIG. 4 for visual reference).

The HEPGS 20 is designed to be located in a river 8 adjacent to any other electrical power generation station 21 of any type in so much as that electrical power generation station 21 is located on land and within a reasonable distance of the river 8 in which the HEPGS 20 is located. The electrical power out 13 of the electrical generator 24 in the HEPGS 20 is carried out via power cables 17 to the immediate shore (see FIG. 4) where it is attached to the electrical grid (not pictured) via an existing power generation station 21 located within a reasonable distance ashore from the HEPGS 20. This precludes the need to increase the size (or capacity) of the existing power grid (not pictured) and also serves to minimize any modifications of the adjacent power generation station 21 to accept the electrical power out 13 of the electrical generators 24 in the HEPGS 20.

What is claimed is:

1. A hydro kinetically powered electrical generation system comprised of:
a horizontally oriented power wheel that rotates about a vertically oriented axis normal to current flow,
that has a plurality of cups affixed to the periphery of said power wheel,
and that is mechanically connected to a electrical generator housing located at the center hub of said power wheel.

2. The disclosure of claim 1 whereas said electrical generator housing is occupied with electrical generators of such size and such configuration determined by:
water current speed available,
mechanical power input available,
and electrical power output required.

3. The disclosure of claim 1 whereas said cups are of determined plurality and are located a determined radius by:
water current speed available
and mechanical power input required.

4. The disclosure of claim 1 whereas said cups are hinged to modulate in and out of the rotational plane of said power wheel.

5. The disclosure of claim 4 whereas the amount of said modulation in and out of the rotational plane is determined by:
water current speed available
and mechanical power input required.

6. The disclosures of claim 1 whereas said electrical generator housing is affixed to a base structure used to elevate said electrical generator housing above the floor of the submerged environment in which it is placed.

7. The disclosure of claim 6 whereas said base structure consist of one or more legs of such size and such shape and such configuration determined by:
total weight of the invention,
the coefficient of drag required for the environment in which it is placed,
and the topography of the environment in which it is placed.

8. The disclosure of claim 7 whereas the said legs are vertically adjustable to regulate the depth of the disclosures in claim 1.

9. The disclosure of claim 7 whereas said legs have foundations at the interface between said legs and the floor of the submerged environment in which they are placed.

10. The disclosure of claim 9 whereas said foundations may have protrusion affixed to the underside of said foundations of such size and such shape and such configuration determined by:
total weight of the invention,
the amount of drag to be overcome for the environment in which it is placed,
and the bottom conditions of the environment in which it is placed.

11. The disclosure of claim 1 whereas said electrical generator housing may be affixed via one or more lanyards to one or more embedded pylons in the floor of the submerged environment in which they are placed.

12. A hydro kinetically powered electrical generation system comprised of:
a horizontally oriented power wheel that rotates about a vertically oriented axis normal to current flow,
that has a plurality of cups affixed to the periphery of said power wheel,
that is mechanically connected to a electrical generator housing located at the center hub of said power wheel,
and that encloses said cups within the outer periphery of said power wheel with an exterior structure.

13. The disclosure of claim 12 whereas said electrical generator housing is occupied with electrical generators of such size and such configuration determined by:
water current speed available,
mechanical power input available,
and electrical power output required.

14. The disclosure of claim 12 whereas said cups are of determined plurality and are located a determined radius by:
water current speed available
and mechanical power input required.

15. The disclosure of claim 12 whereas said cups are hinged to modulate in and out of the rotational plane of said power wheel.

16. The disclosure of claim 15 whereas the amount of said modulation in and out of the rotational plane is determined by:
water current speed available
and mechanical power input required.

17. The disclosures of claim 12 whereas said electrical generator housing is affixed to a base structure used to elevate said electrical generator housing above the floor of the submerged environment in which it is placed.

18. The disclosure of claim 17 whereas said base structure consist of one or more legs of such size and such shape and such configuration determined by:
total weight of the invention,
the coefficient of drag required for the environment in which it is placed,
and the topography of the environment in which it is placed.

19. The disclosure of claim 18 whereas the said legs are vertically adjustable to regulate the depth of the disclosures in claim 12.

20. The disclosure of claim 18 whereas said legs have foundations at the interface between said legs and the floor of the submerged environment in which they are placed.

21. The disclosure of claim 20 whereas said foundations may have protrusion affixed to the underside of said foundations of such size and such shape and such configuration determined by:
total weight of the invention,
the amount of drag to be overcome for the environment in which it is placed,
and the bottom conditions of the environment in which it is placed.

22. The disclosure of claim 12 whereas said electrical generator housing may be affixed via one or more lanyards to one or more embedded pylons in the floor of the submerged environment in which they are placed.
